(19) United States
(12) Patent Application Publication
(10) Pub. No.: US 2024/0324609 A1
(43) Pub. Date: Oct. 3, 2024

(54) DOUGH COMPOSITION AND BAKED FOOD PRODUCTS WITH WHEY PROTEIN CREAM

(71) Applicant: General Mills, Inc., Minneapolis, MN (US)

(72) Inventors: Kristi L. Bahe, Coon Rapids, MN (US); Michelle Manderfeld, Plymouth, MN (US); Cara A. Yarusso, Eagan, MN (US); Constance M. Hederman, Monticello, MN (US); Brent L. Wyrick, Richfield, MN (US); Sara Rosene, New Hope, MN (US); Claire Randolph, Robbinsdale, MN (US)

(21) Appl. No.: 18/615,400

(22) Filed: Mar. 25, 2024

Related U.S. Application Data
(60) Provisional application No. 63/493,591, filed on Mar. 31, 2023.

(51) Int. Cl. A21D 2/26; A21D 13/80

(52) U.S. Cl. CPC A21D 2/263; A21D 13/80

(57) ABSTRACT

A dough composition can be formulated using a whey protein cream ingredient to reduce or replace certain emulsifying agents while maintaining or extending the shelf-life of the final baked food product. The whey protein cream may further be used to reduce or replace additional protein ingredients used in dough formulations. In some formulations, the dough composition may include a comparatively low amount of emulsifying agent or a casein salt, while other formulations are substantially free of an emulsifying agent or casein salt. The inclusion of whey protein cream may beneficially maintain freshness and shelf-life of baked food products from the dough compositions.

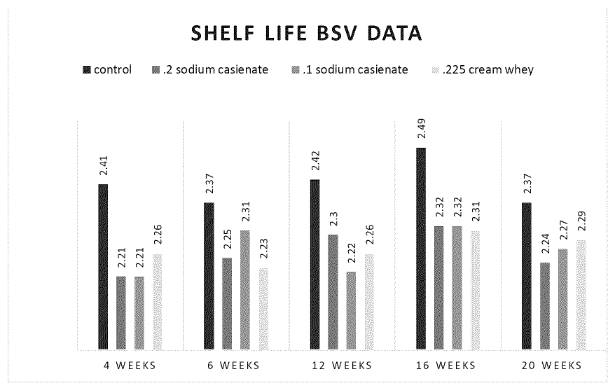

### CROSS-REFERENCE TO RELATED APPLICATIONS

This application claims priority to U.S. Provisional Application No. 63/493,591, filed Mar. 31, 2023, the entire contents of which are incorporated herein by reference.

### TECHNICAL FIELD

This disclosure relates to dough compositions and methods of making the same, including methods of making a baked food product from the dough composition, formulated using whey protein cream.

### BACKGROUND

Baked goods are a popular category of food that includes a wide range of products such as bread, cakes, pastries, muffins, and cookies. One of the key factors in producing high-quality baked goods is achieving a consistent texture and structure. Achieving this consistency can be challenging due to the complex interactions between ingredients, and the chemical and physical changes that occur during the baking process.

Emulsifying agents and casein protein are two food ingredients that have been shown to improve the quality and consistency of baked goods. Emulsifying agents are substances that help to combine ingredients that normally do not mix well, such as oil and water. They work by reducing the surface tension between the two ingredients and creating a more uniform texture. Emulsifying agents are commonly used in baked goods to improve their volume, texture, and shelf-life. An example of a commonly used food emulsifying agent includes diacetyl tartaric acid esters of monoglycerides (DATEM).

Casein is a protein derived from milk that is often used as a food additive to improve the texture and stability of products. It has emulsifying properties that make it an effective ingredient in many baked goods. Casein proteins, such as sodium caseinate, can help to improve the volume, texture, and stability of baked goods, as well as enhance their nutritional value.

Despite the potential benefits of using emulsifying agents and casein protein in baked goods, there are challenges associated with their use as well. For example, the amount of emulsifying agent or casein protein used can impact the final texture, taste, and quality of the baked goods. Additionally, there have been concerns over the potential negative health effects of DATEM, which have led to consumer concerns over the use of DATEM in food products.

Further, cost considerations must be taken into account when using these ingredients in food products. For example, casein is an expensive ingredient used in dough compositions, and moreover, the available supply of casein is limited. For these and other reasons, food manufacturers may attempt to reduce the amount of casein and/or DATEM used in a dough formulation. In light of these concerns, there is a need for alternative emulsifiers and casein substitutes that can be used in baked goods and dough compositions to improve their texture and stability without negative health, quality, and sustainability concerns.

### SUMMARY

Generally, the disclosure relates to the discovery that selection and optimization of ingredients of a dough composition, allows otherwise standard dough ingredients to be processed into a dough composition and/or baked food product, without the necessity for an additional emulsifier. The disclosure further provides for dough composition embodiments where casein protein ingredients are not needed to provide a dough composition suitable for baking into a baked food product.

Applicant has discovered the benefits of using whey protein cream in a dough composition. The whey protein cream can function as a source of protein for the dough composition and can also help to act as an emulsifying agent. As a protein source, the whey protein cream can provide nutritional value for the dough composition and help build the structure of the dough. As an emulsifier, the whey protein cream can help emulsify the constituent components of the composition together, forming a homogenous composition. The whey protein cream may further maintain or improve the freshness of a final baked food product using the dough compositions described herein.

In one example, a dough composition is described that includes flour, shortening, whey protein cream, and water. The flour may range between about 3 wt-% and about 70 wt-% of the composition, the shortening may range between about 0.1 wt-% and about 30 wt-% of the composition, the whey protein cream may range between about 0.05 wt-% to about 5 wt-% of the composition, and the water may range between about 1 wt-% to about 50 wt-% of the composition.

In another example, a method of making a dough is described that includes combining flour, shortening, whey protein cream, and water to form a dough composition. The dough compositions may further include one or more functional ingredients, such as, salt, sweeteners, hydrocolloids, leavening agents, binding agents, flavoring agents, dyes, emulsifying agent, enzymes, and shelf-life stabilizers, are combined with the flour, the shortening, the whey protein cream, and water to form the dough composition.

In another example, a method of making a baked food product is described that includes heating the dough composition as described above at a temperature of from about 300° F. to about 450° F. for a time sufficient to produce the baked food product. The baked food product may include, but is not limited to, muffins, cookies, bread, biscuits, cake, pastry, pies, pizza crust, batter, or bagels.

While multiple embodiments are disclosed, still other embodiments of the present disclosure and FIGURE will become apparent to those skilled in the art from the following detailed description, which shows and describes illustrative embodiments of the disclosure. Accordingly, the detailed description is to be regarded as illustrative in nature and not restrictive.

### BRIEF DESCRIPTION OF DRAWINGS

The FIGURE shows a graph of shelf life BSV data for four biscuit formulations containing whey protein cream in comparison to a control.

### DETAILED DESCRIPTION

This disclosure generally relates to dough compositions containing whey protein cream, food products made from the dough composition, dry mixes for forming dough compositions, and associated methods in which the dough composition is formulated with whey protein cream (optionally with a relatively reduced amount of casein protein and/or non-casein emulsifying agent). The dough composition may be formulated with a limited amount of casein protein, such as in its casein salt form, or in other examples, may not include any added casein protein. In further examples, the dough composition may be formulated with a limited amount of non-casein emulsifying agent. In accordance with examples of the present disclosure, whey protein cream can be added to the dough composition to replace emulsifying agents such as diacetyl tartaric acid ester of monoglycerides and diglycerides (DATEM).

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, time, and distance. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. Whether or not modified by the term “about,” the claims include equivalents to the quantities.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “whey protein cream” as used herein refers to a whey product having a minimum of 50 wt % protein (dry basis), a minimum of 10 wt % fat, a maximum of 8 wt % ash, and a maximum of 10 wt % moisture.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

In general, the dough compositions described may include whey protein cream, flour, shortening, water, and a variety of other optional additives, such as hydrocolloids, sweeteners, leavening agents, flavoring agents, preservatives, etc. In some implementations, the dough composition may include a protein source, such as casein protein. In some regards, traditional dough compositions may include casein protein in the form of a casein salt. The amount of casein salt added to the dough composition, if any, may be relatively reduced to provide a low-casein salt dough composition. In other implementations, the dough compositions may be substantially free of casein salt. The whey protein cream used in the dough composition may substitute for and/or otherwise help compensate for the reduced amount of casein salt present in the composition. The described dough compositions with whey protein cream include a relatively reduced amount of casein salt when compared to otherwise comparable dough compositions, while providing functional, organoleptic, and/or nutritional properties that are suitable notwithstanding the reduced level of casein salt.

In some embodiments, the dough composition with whey protein cream includes one or more non-casein emulsifying agents. The emulsifying agents can help emulsify the hydrophilic and hydrophobic components of the composition to produce a substantially homogenous composition. The amount of emulsifying agent, when used in the dough composition incorporating whey protein cream, may be relatively reduced compared to an otherwise compositionally similar dough composition not utilizing whey protein cream. In other embodiments, the dough composition is substantially free of the non-casein emulsifying agents. In some aspects, the whey protein cream ingredient has been identified to provide properties, allowing the whey protein cream to substitute for and/or otherwise help compensate for a reduction in emulsifying agents that may otherwise be used in the composition.

A dough composition according to disclosure includes whey protein cream. Whey protein cream, also known as whey protein phospholipid concentrate, is a retentate stream of whey protein microfiltration. Whey protein cream can be produced as a coproduct when producing whey protein isolate through the microfiltration or ion exchange of a whey protein concentrate (WPC) stream.

In production, whey protein cream can be produced from the microfiltration or ion exchange of whey protein concentrate. Microfiltration and ion exchange are processes in the dairy industry that separate the majority of whey protein from the other whey protein concentrate constituents (e.g., fat, phospholipids, lactose, minerals). Whey protein cream typically includes at least 50 wt-% protein (dry basis), at least 10 weight percent fat, less than 8 wt-% ash, and less than 10 wt-% moisture. One example standard for characterizing whey protein cream is the American Dairy Products Institute 2015 “Whey Protein Phospholipid Concentrate (WPPC) Standard,” the entire contents of which are incorporated herein by reference.

In various examples, whey protein cream includes at least 10 wt-% fat, such as at least 12 wt-%, at least 13 wt-%, at least 15 wt-%, at least 17 wt-%, at least 20 wt-%, at least 30 wt-% or at least 35 wt-%. The maximum amount of fat in the whey protein cream in one or more of these examples may be less than 50 wt-%, such as less than 40 wt-%, less than 35 wt-%, less than 30 wt-%, less than 25 wt-%, less than 20 wt-%, less than 18 wt-%, less than 17 wt-%, less than 16 wt-%, less than 15 wt-%, less than 14 wt-%, or less than 13 wt-%.

In various examples, whey protein cream includes greater than 50 wt-% protein, such as greater than 52 wt-%, greater than 54 wt-%, greater than 60 wt-%, greater than 62 wt-%, greater than 65 wt-%, or greater than 68 wt-%. The maximum amount of protein in the whey cream in one or more of these examples may be less than 82 wt-%, such as less than 80 wt-%, less than 75 wt-%, less than 70 wt-%, less than 65 wt-%, less than 60 wt-%, less than 55 wt-%, or less than 53 wt-%.

In various examples, whey protein cream includes greater than 1 wt-% lactose, such as greater than 2 wt-%, greater than 3 wt-%, greater than 5 wt-%, greater than 8 wt-%, or greater than 10 wt-%. The maximum amount of lactose in the whey cream in one or more of these examples may be less than 15 wt-%, such as less than 10 wt-%, less than 8 wt-%, less than 6 wt-%, less than 5 wt-%, less than 4 wt-%, less than 3 wt-%, less than 2 wt-%, or less than 1 wt-%.

In general, the whey protein cream includes less than 10 wt-% ash, such as less than 8 wt-%, less than 6 wt-%, less than 5 wt-%, less than 4 wt-%, less than 3 wt-%, less than 2 wt-%, or less than 1 wt-%.

The whey protein cream is typically dried to a moisture content less than 10 wt-%, such as less than 8 wt-%, less than 6 wt-%, less than 5 wt-%, less than 4 wt-%, less than 3 wt-%, less than 2 wt-%, or less than 1 wt-%.

Whey protein cream contains phospholipids naturally found in milk. The most abundant phospholipids may be zwitterionic phospholipids, phosphatidylcholine and phosphatidylethanolamine, and sphingolipid sphingomyelin. These phospholipids are typically at higher concentrations in dried whey protein cream than found in fluid whey.

The amount of whey protein cream incorporated into the dough composition may vary depending on the specific functional, organoleptic, and/or nutritional properties targeted for the dough composition. In different formulations, the dough composition includes at least 0.05 wt-% whey protein cream based on the total weight of the dough composition, such as at least 0.1 wt-%, at least 0.25 wt-%, at least 0.5 wt-%, at least 0.75 wt-%, at least 1.0 wt-%, at least 1.25 wt-%, at least 1.5 wt-%, at least 2.0 wt-%, at least 2.25 wt-%, at least 2.5 wt-%, at least 2.75 wt-%, at least 3.0 wt-%, at least 3.5 wt-%, at least 4.0 wt-%, at least 4.5 wt-%, at least 5.0 wt-%, at least 6.0 wt-%, at least 7.0 wt-%, at least 8.0 wt-%, at least 9.0 wt-%, or at least 10.0 wt-%.

A maximum amount of whey protein cream used in the dough composition may be limited (e.g., within a range bounded by any one of the foregoing minimum limits) to an amount less than 15 wt-% based on the total weight of the dough composition, such as less than 10.0 wt-%, less than 9.0 wt-%, less than 8.0 wt-%, less than 7.0 wt-%, less than 6.0 wt-%, less than 5.0 wt-%, less than 4.5 wt-%, less than 4.0 wt-%, less than 3.5 wt-%, less than 3.0 wt-%, less than 2.5 wt-%, less than 2.0 wt-%, less than 1.0 wt-%, less than 0.75 wt-%, or less than 0.5 wt-%. For example, the amount of whey protein cream used in the dough composition may range from 0.05 wt-% to 15 wt-% based on the total weight of the dough composition, such as from 0.05 wt-% to 10 wt-%, from 0.05 wt-% to 5 wt-%, about 0.05 wt-% to about 3 wt-%, or from about 0.1 wt-% to about 1 wt-%.

In embodiments, the whey protein cream may be in dry form (e.g., powder, particulate). In other embodiments, the whey protein cream may be a liquid whey protein cream. The amount of whey protein cream incorporated into the dough composition may be proportionally adjusted based on the amount of water present in the whey protein cream.

A dough composition according to disclosure may further comprise flour. Suitable flours for the dough composition include those for strengthening the dough composition matrix. Many flours are generally known, useful, or commercially available. The amount of flour added to produce the dough composition can be enough such that the total flour in the dough composition can be effective to provide desired structure and consistency to the dough composition. The total amount of flour in the dough composition should not be so high to cause the dough composition to be dry or weak, i.e., have little extensibility and therefore, reduced ability to expand.

Flours suitable for use include, but are not limited to, any edible flour, such as wheat flour (e.g., hard wheat flour, soft wheat flour, cake flour, pastry flour, and the like), other grain flours (e.g., oat, barley, rice, or the like), seed flours (e.g., quinoa, buckwheat, and the like), nut flours (e.g., almond, cashew, and the like), root flours (e.g., tapioca, potato, and the like), legume flours (e.g., peanut, soy, and the like), unbleached flour, or any combination thereof.

In embodiments, the disclosed compositions can, for example, include flour in an amount of between about 3 wt-% to about 70 wt-%, between about 5 wt-% and 40 wt-%, and between about 7 wt-% and about 30 wt-%.

These amount of total flour in a dough composition may be based on flour having about 13 wt-% to about 15 wt-% moisture, about 5 wt-% to about 14 wt-% wheat protein, and about 0.4 wt-% to about 0.6 wt-% ash based on the amount of flour. One skilled in the art having read this description will readily understand that flour amounts suitable for use with a dough composition can vary on a variety of factors including, for example, the characteristics of flour used and the desired properties of the dough composition and the baked dough product.

A dough composition according to the disclosure may further comprise shortening. Shortening must generally be included in the dough composition. Shortening contributes to a baked dough product having desirable palatability, physical texture, physical form, and overall aesthetic appeal. The shortening generally provides a baked product with a tender, soft, fluffy mouth feel; a light flaky texture; and a crisp outer crust with a glossy appearance. Shortening can also act as a plasticizer and can contribute to the volume and grain of a baked product. Shortening can be natural, for example, animal or vegetable shortening, or synthetic.

Shortenings generally include fats and fatty oils, which are made of predominantly triesters of glycerol with fatty acids, commonly called triglycerides. The number of triglycerides in a given natural fat is a function of the number of fatty acids present and the specificity of the enzyme systems involved in that particular fat-synthesis reaction.

Fats and fatty oils useful in producing shortening consistent with the disclosure include cottonseed oil, ground nut oil, soybean oil, sunflower oil, rape seed oil, sesame oil, olive oil, corn oil, safflower oil, palm oil, palm kernel oil, coconut oil, and combinations thereof.

The dough composition can include any number of shortening compositions having a variety of physical states and/or physical forms. Suitable physical states of shortening include liquid, semisolid, and solid. Suitable physical forms of shortening include plasticized shortening, chip shortening, and extruded shortening. In some aspects, the shortening in the dough composition includes butter, hydrogenated vegetable oil, hydrogenated soybean oil, or a combination thereof.

The amount of shortening in the dough composition is effective to provide a baked product having a tender, soft, fluffy mouth feel, a light, flaky texture, and a crisp outer crust. The amount of shortening should not exceed an amount that would provide a baked product having a gummy texture, yet the amount of shortening should not be so low that a dough composition of the disclosure provides a baked product having a tough, dry, crumbly texture, and a less than desirable specific volume.

In embodiments, the disclosed compositions may include shortening in an amount of between about 0.1 wt-% to about 30 wt-%, between about 0.2 wt-% and 20 wt-%, between about 1 wt-% and about 18%, and between about 5 wt-% and about 15 wt-%.

A dough composition according to disclosure may further comprise water. The amount of water added to the composition can be an amount sufficient to provide the final dough composition with an amount of water that is effective to provide a desirable dough composition consistency.

Water can act as a plasticizer, a leavening agent, or both. When water acts as a plasticizer, water provides the dough composition with extensibility. Desirable extensibility facilitates baking the dough composition into a product having a desirable baked specific volume. Moreover, water can facilitate the leavening of the dough composition by forming steam, which acts to expand the dough.

The amount of water from all sources, for example, water, eggs, milk, etc., should not be so high that the dough composition becomes so soft that it cannot maintain a desired structure. On the other hand, the amount of water should not be so low that the dough composition is dry and has no ability to expand, i.e., extensibility.

In some embodiments, the dough composition may optionally comprise a protein component in addition to the whey protein cream. Protein can influence functional, organoleptic, and nutritional properties of a dough composition. Proteins that can be used in the dough composition include dairy proteins like casein protein, non-casein dairy proteins, and non-dairy proteins such as vital wheat gluten protein.

The additional proteins that may be incorporated into the dough compositions include, but are not limited to, egg white protein, wheat protein, wheat gluten, buttermilk solids, milk powders, egg protein, whole egg solids, egg yolk (including dried), canola protein, pea protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates, edible bean proteins, wheat protein concentrate, textured wheat protein powder, sweetened composite protein, textured wheat protein, textured vegetable protein, whey protein concentrate, rice protein concentrate, zein, a denatured protein, an oil seed protein, a hydrolyzed protein, cheese, a textured protein, a fish protein, an amino acid, a peptide, collagen, casein protein, an animal protein, a single cell protein, flax protein, flax meal, and combinations of any thereof.

In some embodiments, the dough compositions contain a traditional amount of egg protein typically used in dough compositions. In other words, the inclusion of whey protein cream does not obviate the need for egg protein. Examples of egg protein include, but are not limited to, whole egg solids, egg yolk (including dried), and egg white protein (including dried). In some embodiments, the dough composition includes whey protein cream and an additional protein comprising egg protein. The egg protein may be present in the composition in an amount of between about 0.5 wt-% to about 10 wt-%, about 1 wt-% to about 8 wt-%, or about 1 wt-% to about 5 wt-%.

In embodiments, the incorporation of the whey protein cream replaces the need to include a casein protein in the disclosed dough compositions. Casein protein is an edible protein that can be found naturally in milk and that is conventionally known to provide many important characteristics in some baked product compositions. As used herein, the term “casein protein” means casein in all its forms, including rennet casein, acid casein, and caseinate derivatives. The casein protein may include the protein itself, and other times may be a casein salt. An example of a casein salt includes sodium caseinate. In some embodiments, the dough compositions including whey protein cream comprise casein salt in amount less than found in traditional dough compositions. For example, the casein salt may be provided in the dough composition in an amount of less than 1 wt-%, less than 0.75 wt-%, or less than 0.5 wt-% based on the total weight of the dough. In other embodiments, the dough compositions including whey protein cream are substantially free of casein salt. In further embodiments, the dough compositions including whey protein cream are free of casein salt.

In further implementations, the dough composition may optionally include one or more emulsifying agents. An emulsifier can influence the texture and homogeneity of the dough composition mixture, increase dough composition stability, and improve the eating quality of a baked product. Suitable emulsifying agents include, for example, lecithin, mono- and diglycerides of fatty acids, propylene glycol monoesters and diesters of fatty acids, glyceryl-lacto esters of fatty acids, ethoxylated monoglycerides and diglycerides, sodium stearoyl lactylate (SSL), diacetyl tartaric acid ester of monoglycerides and diglycerides (DATEM), monosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, sodium potassium tartrate, and combinations thereof.

When used, a relatively decreased amount of one or more emulsifying agent may be incorporated into the dough composition incorporating the whey protein cream. The emulsification properties provided by the whey protein cream may substitute for, or otherwise allow for a reduction in, the amount of emulsifying agent used in the dough composition. In some examples where the dough composition includes a casein salt, the casein salt may be added to function as an emulsifying agent. In such cases, the dough composition may include one or more additional non-casein emulsifying agents as listed above. In other cases where the dough compositions comprise casein salt, the dough composition may be substantially free of any additional non-casein emulsifying agents as listed above.

The actual weight percentage of emulsifying agent incorporated into the dough composition may vary depending on the amount of casein salt, whey protein cream, and/or other ingredients incorporated into the dough composition. When used, the amount of non-casein emulsifying agent may typically be within a range of from about 0.01 wt-% to about 5 wt-% based on the total weight of the dough composition, such as from 0.05 weight percent to 3 wt-% weight percent.

In other implementations, the dough composition containing whey protein cream can be formulated without using any emulsifying agents. In other words, the dough composition containing whey protein cream may be devoid of emulsifying agents, or substantially free of emulsifying agents. The whey protein cream may provide sufficient emulsification properties for the dough composition to eliminate the need for added emulsification agents. In some examples, the dough composition is substantially free of a monoglyceride and/or diglyceride emulsifying agent. In further examples, the dough composition is substantially free of DATEM.

A dough composition according to the disclosure may optionally comprise one or more additional functional ingredients. The one or more functional ingredients may be any ingredient known in the baked food product and dough composition arts. Such optional additional functional ingredients include, but are not limited to salt, sweeteners, hydrocolloids, leavening agents, binding agents, flavoring agents, dyes, emulsifying agents, additional proteins, enzymes, acidifying agents, and shelf-life stabilizers.

Salt can enhance the flavor of a baked product prepared from a dough composition of the disclosure, impart toughness to the gluten, and provide strength to the crumb. Salt can be present in an amount effective to provide a desirable flavor. Salt is typically present in a range of between about 0.1 wt-% and about 5 wt-%, about 0.2 wt-% and about 4 wt-%, or about 0.3 wt-% and about 3 wt-%.

In some embodiments, a sweetener (e.g., a sugar, a sugar alcohol, sugar substitute or mixtures thereof) can be included in the disclosed dough composition. A sweetener can enhance the flavor of a baked product prepared from a dough composition of the disclosure. In examples, sugar acts as a substrate for yeast and as a starting material for the Maillard reaction, which facilitates color formation of the crust. Useful sweeteners can include, but are not limited to, monosaccharides, disaccharides, polysaccharides, sugar alcohols, sugar degradation products or combinations thereof. Examples of suitable sugars include, but are not limited to, pentoses, xylose, arabinose, glucose, galactose, amylose, fructose, sorbose, lactose, maltose, dextrose, sucrose, maltodextrins, high fructose corn syrup, molasses, honey, powdered sugar, brown sugar, granulated sugar, liquid sugar, fine sugar, and combinations thereof. Suitable sugar alcohols include isomalt, lactitol, maltitol, mannitol, sorbitol, erythritol, xylitol, glycerol/glycerin, and combinations thereof. In some embodiments, a sweetener can be comprised of a sugar substitute. Useful sugar substitutes can include stevia plant extracts (e.g., Truvia® (developed by Cargill and The Coca-Cola Company) and PureVia™ (developed by PepsiCo and the Whole Earth Sweetener Company)), saccharine, sucralose, polydextrose, aspartame, potassium acetylsulfame, cyclamate, neotame, alitame, and combinations thereof. In some embodiments, a sweetener, can be included in an amount of at least 0.1 wt-%, at least 0.5 wt-%, at least 1 wt-%, at least 2 wt-%, at least 3 wt-%, at least 5 wt-%, at least 10 wt-%, or at least 15 wt-%. In some embodiments, the sweetener may be included in the dough composition at an amount of less than about 50 wt-%, less than about 45 wt-%, less than about 40 wt-%, or less than about 35 wt-%.

Typical hydrocolloids used in the food production industry are polysaccharides and and/or gelling and/or colloidal proteins that can function to control, for example, the stability, texture, and/or organoleptic properties of a food product. Hydrocolloids that may be usefully employed in the dough composition include agar, alginate, carrageenan, gelatin, guar gum, locust bean gum, pectin, xanthan gum, starch, and combinations thereof. When used, one or more hydrocolloids may be incorporated into the dough composition in an amount of from about 0.05 wt-% to about 10 wt-% based on the total weight of the of the dough composition, such as from about 0.1 wt-% to about 5 wt-%, or from about 0.2 wt-% to about 2 wt-%. When starch is used, the starch can be procured from one or more sources such as corn, potato, sweet potato, wheat, rice, sago, tapioca, sorghum, and other plant sources.

The dough composition of the disclosure may optionally include a leavening agent to, during baking, metabolize and increase the volume, and alter the texture of a baked product prepared from a dough composition. The amount of leavening agents included in the dough composition, such as, but not limited to, yeast, sodium acid pyrophosphate (SAPP), sodium bicarbonate, sodium aluminate phosphate (SALP), carbon dioxide, bubbles, air, steam, etc., cause leavening of a dough composition during baking. A leavening agent can be present in the dough composition in an amount of between about 0.5 wt-% and about 15 wt-%, between about 1 wt-% and about 10 wt-%, or between about 2 wt-% and about 8 wt-%, based on the total weight of the dough.

A variety of flavoring agents suitable for use in food product compositions may be included in the dough composition of the disclosure. Flavoring agents may be included in the dough compositions to enhance the taste and aroma of the final baked food product. Examples of suitable flavoring agents include, but are not limited to, flavoring extracts (i.e., vanilla, almond, peppermint, etc.), spices, fruit (including frozen fruit and zest), fruit flavoring, cocoa powder, buttermilk powder and flavoring, and combinations thereof.

Shelf-stabilizers, such as, for example, preservatives and mold inhibitors can be added to a dough composition of the disclosure. Suitable shelf-life stabilizers include, for example, sodium or potassium salts of propionic or sorbic acids, sodium diacetate, monocalcium phosphate, lactic acid, acetic acid, citric acid, stearoyl lactylate, ascorbic acid, and combinations thereof. The shelf-life stabilizers may be present in an amount of less than about 5 wt-%, less than about 4 wt-%, or less than about 3 wt-%.

Further provided are methods of making a dough composition and methods of making a baked food product as further described herein. The dough compositions as described within the present disclosure may be formed by combining a flour, a shortening, a whey protein cream, and water. One or more additional functional ingredients as described herein may be further incorporated into the dough composition by any useful methods, as will be understood, based on this description and by one of ordinary skill in the art of dough compositions and processing. The components of the dough composition can generally be combined with additional functional ingredients in any manner that allows for the production of a dough composition. Conventional and known methods of preparing dough products will be useful, such as, by mixing.

The components of the dough composition can be combined with optional functional ingredients as necessary or useful, and as appropriate, depending on the type and composition of the intended final baked food product. In embodiments, the dry components will be combined first before adding the wet ingredients. In examples, the flour and whey protein cream (if provided in dry form) are combined first before adding the shortening and water. In some aspects, the wet ingredients may optionally be combined first before being added to the dry ingredients. In further embodiments, the dry ingredients are not mixed, and the wet ingredients are not mixed, prior to combining the wet ingredients with the dry ingredients.

The components of the dough composition may be combined for a time sufficient to form the dough composition. Depending on the formulation of the dough, the time sufficient may vary. In some embodiments, the components are combined for a time period of less than about 10 minutes, less than about 8 minutes, less than about 7 minutes, or less than about 6 minutes.

The dough composition may be further baked or heated in any appropriate device, such as a convection over or a conventional oven, at a temperature of from about 300° F. to about 450° F. (e.g., from about 325° F. to about 425° F., from about 350° F. to about 400° F., or from about 375° F. to about 400° F., and the like). The amount of time can be increased at a lower baking temperature or decreased at a higher baking temperature, to result in the desired qualities of the baked food product. The amount of baking time used can also be adjusted based on the size of the dough composition. For example, a dough composition having a lower weight can be heated for less time to produce a baked food product than a dough composition having a greater weight.

In some aspects, the inclusion of the whey protein cream ingredient has been identified to provide properties, allowing the whey protein cream to substitute for and/or otherwise help compensate for a reduction in emulsifying agents that may otherwise be used in the composition. The methods may provide for dough compositions wherein the inclusion of the whey protein cream obviates the need to include a monoglyceride and/or diglyceride emulsifying agent. In other aspects, the inclusion of the whey protein cream results in a dough composition having less than 0.5 wt-% of an emulsifying agent. In further aspects, the inclusion of the whey protein cream results in a dough composition that is substantially free of casein salt, and wherein substantially all protein in the dough composition is whey protein cream. In other embodiments, the inclusion of whey protein cream results in less than about 0.5 wt-% of casein salt.

The dough composition provides suitable baked specific volume (BSV) upon baking. The BSV of a product relates the volume of the baked food product to the weight of the food product. Generally, food products with higher BSVs are lighter and have more gas or air incorporated into the product. Products with lower BSVs are heavy, dense, and generally are undesirable in developed doughs, however, may be more suitable for baked goods such as, for example, biscuits, shortbread cookies, or bagels. The BSV is an important quality parameter for baked food products because it provides information about the texture and structure of the product. A higher BSV indicates that the product has a more open and airy texture, while a lower BSV suggests that the product is denser and has a tighter crumb structure.

BSV can be measured using commonplace displacement methods. One example of a method commonly used is the rapeseed method. In this method, a baked food product of a known mass is placed in a container containing a known and measurable volume of rapeseed. Once the baked food product is placed in the container containing the baked food product, the volume of the rapeseed and baked food product is measured. The specific volume of the baked food product is then determined by dividing the volume of the baked food product by the mass of the baked food product.

Generally, BSV is reported in ml/g developed dough products such as baked breads and rolls generally have BSVs of from about 4 ml/g to 7 ml/g. Dough products, such as baked breads and rolls generally have improved BSVs. Improved BSVs can refer to higher values of BSV or similar values of BSV obtained with a shorter mixing time for the dough.

The dough compositions formed using the methods disclosed herein may be used to make a variety of baked food products. In some examples, the dough composition is used to make a baked food product including, but not limited to, muffins, cookies, bread, biscuits, cake, pastry, pics, pizza crust, batter, or bagels.

### EXAMPLES

The following examples are intended to illustrate particular embodiments of the disclosure and are not intended to limit the scope of the claimed disclosure.

### Example 1: Emulsifier Replacement with Whey Protein Cream

A variety of blueberry muffin dough compositions were formed that each included flour, a shortening, whey protein cream, and water. Different dough compositions tested as part of the example were identically formulated except for the use of different protein sources in different samples and/or use of emulsifiers. Formulation (1) was the control formulation and included both whole egg solids (WES) protein as well as a monoglyceride emulsifying agent, but did not contain whey protein cream. Formulation (2) included a 50 wt-% reduction in WES as well as addition of 0.4 wt-% of whey protein cream. Formulation (3) included a 50 wt-% reduction in WES, 0 wt-% of the monoglyceride emulsifying agent, and addition of 0.4 wt-% of whey protein cream. Formulation (4) was one of the negative control formulations and included a 50 wt-% reduction in WES, but did not contain any whey protein cream. Formulation (5) was another negative control formulation and included a 50 wt-% reduction in WES and 0 wt-% of a monoglyceride emulsifying agent. The formulations are provided in Table 1 below.

The procedure to make the dough composition included adding all of the dry ingredients to a mixer bowl with a paddle attachment, where the dry ingredients were mixed for 2 minutes on low speed. Water and the shortening were then added to the dry ingredients while the mixer bowl was stopped. Once the water and shortening were added, the contents within the mixer bowl were mixed for 3 minutes on low speed. Frozen blueberries were measured out and added to the mixer bowl and mixed on low for 15 seconds.

A 12-count muffin tin with muffin liners were placed on a scale. About 85 g of mixture were added to each cup. The muffin dough composition was not frozen prior. An oven was pre-heated to 400° F., and once heated to 400° F., the muffin tin with dough composition was placed in the oven for 22 minutes and removed immediately. The muffins were left to cool in the muffin tin until easier to handle and placed on a cooling rack. The muffins were left for about an hour before eating and collecting the data.

TABLE 1

| | Formulation (wt-%) | | | | |
|---|---|---|---|---|---|
| Component | (1) - Control | (2) | (3) | (4) | (5) |
| Flour | 22.15 | 22.55 | 22.65 | 22.74 | 22.84 |
| Shortening | 12.45 | 12.45 | 12.45 | 12.45 | 12.45 |
| Whey Protein | — | 0.40 | 0.40 | — | — |
| Cream | | | | | |
| Whole Egg | 2.50 | 1.25 | 1.25 | 1.25 | 1.25 |
| Solids (WES) | | | | | |
| Monoglyceride | 0.20 | 0.20 | — | 0.20 | — |
| emulsifying | | | | | |
| agent | | | | | |
| Sweetener | 23.39 | 23.39 | 23.39 | 23.39 | 23.39 |
| Hydrocolloid(s) | 1.42 | 1.42 | 1.42 | 1.42 | 1.42 |
| Salt | 0.34 | 0.34 | 0.34 | 0.34 | 0.34 |
| Leavening | 0.64 | 0.64 | 0.64 | 0.64 | 0.64 |
| Agent(s) | | | | | |
| Shelf-life | 0.18 | 0.18 | 0.18 | 0.18 | 0.18 |
| Stabilizer | | | | | |
| Flavoring Agent | 12.25 | 12.25 | 12.25 | 12.25 | 12.25 |
| (Flavorings and | | | | | |
| frozen | | | | | |
| blueberries) | | | | | |
| Water | 24.48 | 24.93 | 25.03 | 25.14 | 25.24 |
| Total | 100 | 100 | 100 | 100 | 100 |

A fresh baked organoleptic evaluation was completed on each of the formulations the day the muffins were baked. An aged organoleptic evaluation was further completed on each of the formulations five days after the muffins were baked. Each of the evaluations had three tasters. The following were evaluated: moistness, texture, crumb structure, freshness, and blueberry flavor. Crumb structure was only evaluated in the fresh baked organoleptic evaluation. The results of the fresh organoleptic evaluation is provided in Table 2A below, and the results of the aged organoleptic evaluation is provided in Table 2B below.

Further, the muffin weight, bake volume, and BSV were further evaluated for each of the formulations. Each formulation was evaluated three times, with the average results provided in Table 3 below.

TABLE 2A

| | | Texture: 1-5 | Crumb | | Blueberry |
|---|---|---|---|---|---|
| | Moistness: 1-4 | (Cohesive- | Structure: 1-5 | Freshness: 1-5 | Flavor: 1-5 |
| Formulation | (Dry-Moist) | Crumbly) | (Closed-Open) | (Stale-Fresh) | (Low-High) |
| (1) | 3 | 3 | 3 | 3 | 3 |
| (2) | 3 | 3 | 2.33 | 2.66 | 1.66 |
| (3) | 3.33 | 2.33 | 3.5 | 3 | 3.33 |
| (4) | 3.33 | 1.66 | 2.33 | 3.33 | 2.33 |
| (5) | 3.66 | 2 | 3.66 | 3 | 2 |

TABLE 2B

| | | Texture: 1-5 | | Blueberry |
|---|---|---|---|---|
| Formula- | Moistness: 1-4 | (Cohesive- | Freshness: 1-5 | Flavor: 1-5 |
| tion | (Dry-Moist) | Crumbly) | (Stale-Fresh) | (Low-High) |
| (1) | 3 | 3 | 3 | 3 |
| (2) | 3.66 | 3 | 3 | 2.5 |
| (3) | 3.66 | 2.33 | 3 | 2.8 |
| (4) | 3 | 2 | 3 | 3.33 |
| (5) | 2.66 | 3 | 2.33 | 2.33 |

TABLE 3

| | Average | | |
|---|---|---|---|
| Formulation | Weight (g) | Volume (mL) | BSV (mL/g) |
| (1) | 74.63 | 161.3 | 2.16 |
| (2) | 74.16 | 150 | 2.02 |
| (3) | 75.05 | 148 | 1.97 |
| (4) | 75.62 | 155.7 | 2.06 |
| (5) | 76.2 | 148 | 1.94 |

The results demonstrate that with the inclusion of whey protein cream, when the muffins were tasted fresh, the texture was more cohesive than the formulations not containing whey protein cream. Further, Table 2B demonstrates that whey protein cream may be used as an emulsifier to increase perceived moistness and freshness. The formulations containing whey protein cream had the highest rating compared to the other formulations after being aged five days.

### Example 2: Shelf Life BSV

A variety of biscuit dough compositions were formed that each included flour, a shortening, whey protein cream, and water. Different dough compositions tested as part of the example were identically formulated except for the use of different protein sources in different samples. Formulation 1 was the control formulation with the inclusion of 0.75 wt-% of sodium caseinate and no inclusion of whey protein starch. Formulation 2 was the “0.2 sodium caseinate” formulation which included 0.225 wt-% of whey protein cream and 0.2 wt-% of sodium caseinate. Formulation 3 was the “0.1 sodium caseinate” formulation which included 0.225 wt-% of whey protein cream and 0.1 wt-% of sodium caseinate. Formulation 4 was the “0.225 cream whey” formulation which included 0.225 wt-% of whey protein cream and no inclusion of sodium caseinate. The formulations are provided in Table 4 below.

TABLE 4

| | Formulation (wt-%) | | | |
|---|---|---|---|---|
| | 1 | 2 | 3 | 4 |
| Component | (Control) | (.2 sodium caseinate) | (.1 sodium caseinate) | (.225 cream whey) |
| Flour | 46.9 | 47.11 | 46.96 | 46.96 |
| Shortening | 11.54 | 11.54 | 11.54 | 11.54 |
| Whey Cream | — | 0.225 | 0.225 | 0.225 |
| Protein | | | | |
| Sodium | 0.75 | 0.2 | 0.1 | — |
| Caseinate | | | | |
| Enzymes | 0.04 | 0.04 | 0.04 | 0.04 |
| Flavoring | 2.49 | 2.49 | 2.49 | 2.49 |
| Agent(s) | | | | |
| Shelf-Life | 1.25 | 1.25 | 1.25 | 1.25 |
| Stabilizer | | | | |
| Salt | 1.02 | 1.02 | 1.02 | 1.02 |
| Leavening | 1.15 | 1.15 | 1.15 | 1.15 |
| Agent | | | | |
| Emulsifying | 1.25 | 1.25 | 1.25 | 1.25 |
| agent(s) | | | | |
| Sweetener | 1.73 | 1.73 | 1.73 | 1.73 |
| Hydrocolloid | — | 0.25 | 0.25 | 0.25 |
| Water | 31.88 | 31.94 | 32.06 | 32.16 |
| Total | 100 | 100 | 100 | 100 |

The BSV of each formulation was measured at 4 weeks, 6 weeks, 12 weeks, 16 weeks, and 20 weeks from the day the formulations were baked. The results of the BSV data can be found in the FIGURE. As shown in the FIGURE, the BSV data for each formulation remained relatively consistent from week 4 through week 20 when whey protein cream was included in the formulation. Formulation 4 (without sodium caseinate) appeared to provide the most consistent BSV data throughout the weeks.

1. A dough composition comprising:
a flour;
a shortening;
whey protein cream; and
water.

2. The composition of claim 1, wherein the composition comprises the flour in an amount of between about 3 wt-% and about 70 wt-%.

3. The composition of claim 1, wherein the composition comprises the shortening in an amount of between about 0.1 wt-% and about 30 wt-%.

4. The composition of claim 1, wherein the composition comprises the whey protein cream in an amount of between about 0.05 wt-% to about 5 wt-%.

5. The composition of claim 1, wherein the composition comprises the water in an amount of between about 1 wt-% to about 50 wt-%.

6. The composition of claim 1, wherein the composition comprises a casein salt in an amount of less than 1 wt-%.

7. The composition of claim 6, wherein the composition is substantially free of the casein salt.

8. The composition of claim 1, wherein the composition is substantially free of a monoglyceride and/or diglyceride emulsifying agent.

9. The composition of claim 1, wherein the composition comprises one or more additional functional ingredients selected from the group consisting of salt, sweeteners, hydrocolloids, leavening agents, binding agents, flavoring agents, dyes, emulsifying agent, enzymes, and shelf-life stabilizers.

10. The composition of claim 1, wherein the composition further comprises an additional protein selected from the group consisting of an egg white protein, wheat protein, wheat gluten, buttermilk solids, milk powders, egg protein, whole egg solids, dried egg yolk, canola protein, pea protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates, edible bean proteins, wheat protein concentrate, textured wheat protein powder, sweetened composite protein, textured wheat protein, textured vegetable protein, whey protein concentrate, rice protein concentrate, zein, a denatured protein, an oil seed protein, a hydrolyzed protein, cheese, a textured protein, a fish protein, an amino acid, a peptide, collagen, casein, an animal protein, a single cell protein, flax protein, flax meal, and combinations of any thereof.

11. A method of making a dough composition comprising:
combining a flour, a shortening, a whey protein cream, and water to form a dough composition.

12. The method of claim 11, wherein the flour and whey protein cream are combined first before adding the shortening and water, and wherein the flour, the shortening, the whey protein cream, and the water are combined for a time sufficient to form the dough composition.

13. The method of claim 11, wherein one or more additional functional ingredients selected from the group consisting of salt, sweeteners, hydrocolloids, leavening agents, binding agents, flavoring agents, dyes, emulsifying agent, enzymes, and shelf-life stabilizers, are combined with the flour, the shortening, the whey protein cream, and water to form the dough composition.

14. The method of claim 11, wherein the dough composition is used to make a baked food product comprising muffins, cookies, bread, biscuits, cake, pastry, pies, pizza crust, batter, or bagels.

15. The method of claim 11, wherein the inclusion of the whey protein cream obviates the need to include a monoglyceride and/or diglyceride emulsifying agent.

16. The method of claim 11, wherein the inclusion of the whey protein cream results in a dough composition having less than 0.5 wt-% of an emulsifying agent.

17. A method of making a baked food product comprising:
heating the dough composition according to claim 1 at a temperature of from about 300° F. to about 450° F. for a time sufficient to produce the baked food product.

18. The method of claim 17, wherein the baked food product comprises muffins, cookies, bread, biscuits, cake, pastry, pies, pizza crust, batter, or bagels.

19. The method of claim 17, wherein the inclusion of the whey cream protein obviates the need to include a monoglyceride and/or diglyceride emulsifying agent.

20. The method of claim 17, wherein the inclusion of the whey protein cream results in a baked food product having less than 0.5 wt-% of an emulsifying agent.
